(19) United States
(12) Patent Application Publication
(10) Pub. No.: US 2012/0191720 A1
(43) Pub. Date: Jul. 26, 2012

(54) RETRIEVING RADIOLOGICAL STUDIES USING AN IMAGE-BASED QUERY

(75) Inventors: Merlijn Sevenster, Chicago, IL (US); Yuechen Qian, Briarcliff Manor, NY (US); Robbert Christiaan Van Ommering, Hapert (NL); Reinhard Kneser, Aachen (DE); Dieter Geller, Aachen (DE)

(73) Assignee: KONINKLIJKE PHILIPS ELECTRONICS N.V., EINDHOVEN (NL)

(21) Appl. No.: 13/499,424

(22) PCT Filed: Sep. 17, 2010
(86) PCT No.: PCT/IB2010/054202

§ 371 Date: Mar. 30, 2012

(30) Foreign Application Priority Data
Oct. 1, 2009 (EP) 09171984.9

(51) Int. Cl. G06F 17/30

(52) U.S. Cl. 707/740; 707/758; 707/748; 707/E17.089; 707/E17.061

(57) ABSTRACT

The invention relates to a system (100) for identifying a document of a plurality of documents, based on a multidimensional image, the system (100) comprising an object unit (110) for identifying an object represented in the multidimensional image, based on a user input indicating a region of the multidimensional image, and further based on a model for modeling the object, determined by segmentation of the indicated region of the multidimensional image; a keyword unit (120) for identifying a keyword of a plurality of keywords, related to the identified object, based on an annotation of the model for modeling the object; and a document unit (130) for identifying the document of the plurality of documents, based on the identified keyword. Thus, the system advantageously facilitates a user's access to documents comprising information of interest based on a viewed multidimensional image. The document may be identified by its name or, preferably, by a link to the document. By following the link, the system may be further adapted to allow the user to retrieve the document stored in a storage comprising the plurality of documents, e.g. download a file comprising the document, and view the document on a display.

### FIELD OF THE INVENTION

The invention relates to identifying documents, based on an image query, and more specifically, based on a region of the image indicated by a user.

### BACKGROUND OF THE INVENTION

In their daily workflow, radiologists encounter cases for which they need additional information to accurately interpret the cases shown in viewed X-ray, CT, MR, or other multidimensional images. One possible source of information is previous cases described in case reports or studies. Such case reports or studies are documents stored in a database. A typical way to query the database for a document is by typing a string of characters that comprises a key relating to the information needed be a user.

### SUMMARY OF THE INVENTION

It would be advantageous to facilitate a user's access to documents comprising information of interest, based on a viewed multidimensional image.

Thus, in an aspect, the invention provides a system for identifying a document of a plurality of documents, based on a multidimensional image, the system comprising:

an object unit for identifying an object represented in the multidimensional image, based on a user input indicating a region of the multidimensional image, and further based on a model for modeling the object, determined by segmentation of the indicated region of the multidimensional image;

a keyword unit for identifying a keyword of a plurality of keywords, related to the identified object, based on an annotation of the model for modeling the object; and

a document unit for identifying the document of the plurality of documents, based on the identified keyword.

Thus, the system advantageously facilitates a user's access to documents comprising information of interest, based on a viewed multidimensional image. The document may be identified by its name or, preferably, by a link to the document. By following the link, the system may be further adapted to allow the user to retrieve the document stored in a storage comprising the plurality of documents, e.g. download a file comprising the document, and view the document on a display.

In the six embodiments of the system according to the invention described below, identifying the document of interest is made more interactive, thereby offering the user an intuitive way of navigating to the document of interest.

In an embodiment of the object unit of the system, identifying the object represented in the multidimensional image comprises:

displaying a set of candidate objects, each candidate object being identified based on the user input indicating the region of the multidimensional image, and further based on a model for modeling the candidate object, determined by segmentation of the indicated region of the multidimensional image; and

obtaining a user input for selecting a candidate object from the displayed set of candidate objects, thereby identifying the object.

The identified candidate objects may be represented by their names or icons, for example. Thus, the system helps coping with the situation where more than one candidate object is identified by the object unit on the basis of the user input.

In an embodiment of the object unit of the system, identifying the object represented in the multidimensional image comprises computing and displaying a score of each candidate object of the set of candidate objects. The score helps the user to select the candidate objects from the displayed set of candidate objects.

In an embodiment of the keyword unit of the system, identifying the keyword of the plurality of keywords, related to the identified object, comprises:

displaying a set of candidate keywords of the plurality of keywords, each candidate keyword being related to the identified object, based on an annotation of the model for modeling the object; and

obtaining a user input for selecting a candidate keyword from the displayed set of candidate keywords, thereby identifying the keyword.

Thus, the system helps coping with the situation where more than one candidate keyword is identified by the keyword unit on the basis of the annotation of the object model corresponding to the object identified in the multidimensional image.

In an embodiment of the keyword unit of the system, identifying the keyword represented in the multidimensional image comprises computing and displaying a score of each candidate keyword of the set of candidate keywords. The score helps the user to select the candidate keyword from the displayed set of candidate keywords.

In an embodiment of the document unit of the system, identifying the document of the plurality of documents comprises:

displaying a set of candidate documents of the plurality of documents, each candidate document being identified based on the identified keyword; and

obtaining a user input for selecting a candidate document from the displayed set of candidate documents, thereby identifying the document.

The candidate documents may be represented by their names or icons, for example. Thus, the system helps coping with the situation where more than one candidate document is identified by the document unit on the basis of the identified keyword.

In an embodiment of the document unit of the system, identifying the document represented in the multidimensional image comprises computing and displaying a score of each candidate document of the set of candidate documents. The score helps the user to select the candidate document from the displayed set of candidate documents.

In an embodiment, the system further comprises a fragment unit for labeling text fragments of documents with labels comprising keywords of the plurality of keywords, and the document is identified by the document unit, based on the labels. The fragment unit comprising a natural language processing tool is adapted to label fragments of the document comprising the natural language. The labels comprising keywords are then used by the document unit to identify the documents of interest.

In an embodiment, the system further comprises a category unit for identifying a category of the object represented in the multidimensional image, and the object unit is adapted to identify the object further, based on the identified category of the object. The category may be comprised explicitly in the user input, e.g. as information for qualifying the object to be identified such as information for use by a pixel or voxel classifier, or may be derived from the user input and the multidimensional image, e.g. based on an analysis of the region indicated in the user input and/or its surroundings.

In an embodiment of the system, the category of the object represented in the multidimensional image is a position of the object, and the category unit is adapted to identify the position of the object, based on a reference object identified in the multidimensional image. The reference object may be identified using image segmentation. The object identified by the object unit may be the reference object. This embodiment allows differentiating between identical objects in different positions or taking into account objects that are only partially comprised in the indicated region, for example.

In an embodiment, the system further comprises a retrieval unit for retrieving the identified document.

In a further aspect, the system according to the invention is comprised in a database system.

In a further aspect, the system according to the invention is comprised in an image acquisition apparatus.

In a further aspect, the system according to the invention is comprised in a workstation.

In a further aspect, the invention provides a method of identifying a document of a plurality of documents, based on a multidimensional image, the method comprising:

an object step for identifying an object represented in the multidimensional image, based on a user input for identifying the object, and further based on a model for modeling the object, determined by segmentation of the multidimensional image;

a keyword step for identifying a keyword of a plurality of keywords, related to the identified object, based on an annotation of the model for modeling the object; and

a document step for identifying the document of the plurality of documents, based on the identified keyword.

In a further aspect, the invention provides a computer program product to be loaded by a computer arrangement, the computer program comprising instructions for retrieving a document of a plurality of documents, based on a multidimensional image, the computer arrangement comprising a processing unit and a memory, the computer program product, after being loaded, providing said processing unit with the capability to carry out steps of the method.

It will be appreciated by those skilled in the art that two or more of the above-mentioned embodiments, implementations, and/or aspects of the invention may be combined in any way deemed useful.

Modifications and variations of the database system, of the image acquisition apparatus, of the workstation, of the method, and/or of the computer program product, which correspond to the described modifications and variations of the system or of the method, can be carried out by a person skilled in the art on the basis of the description.

A person skilled in the art will appreciate that the multidimensional image in the claimed invention may be 2-dimensional (2-D), 3-dimensional (3-D) or 4-dimensional (4-D) image data, acquired by various acquisition modalities such as, but not limited to, X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

The invention is defined in the independent claims. Advantageous embodiments are defined in the dependent claims.

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 shows a block diagram of an exemplary embodiment of the system;

FIG. 2 shows an exemplary graphical user interface of the system according to an exemplary embodiment;

FIG. 3 shows a flowchart of exemplary implementations of the method;

FIG. 4 schematically shows an exemplary embodiment of the database system; and

FIG. 5 schematically shows an exemplary embodiment of the image acquisition apparatus; and

FIG. 6 schematically shows an exemplary embodiment of the workstation.

Identical reference numerals are used to denote similar parts throughout the Figures.

### DETAILED DESCRIPTION OF EMBODIMENTS

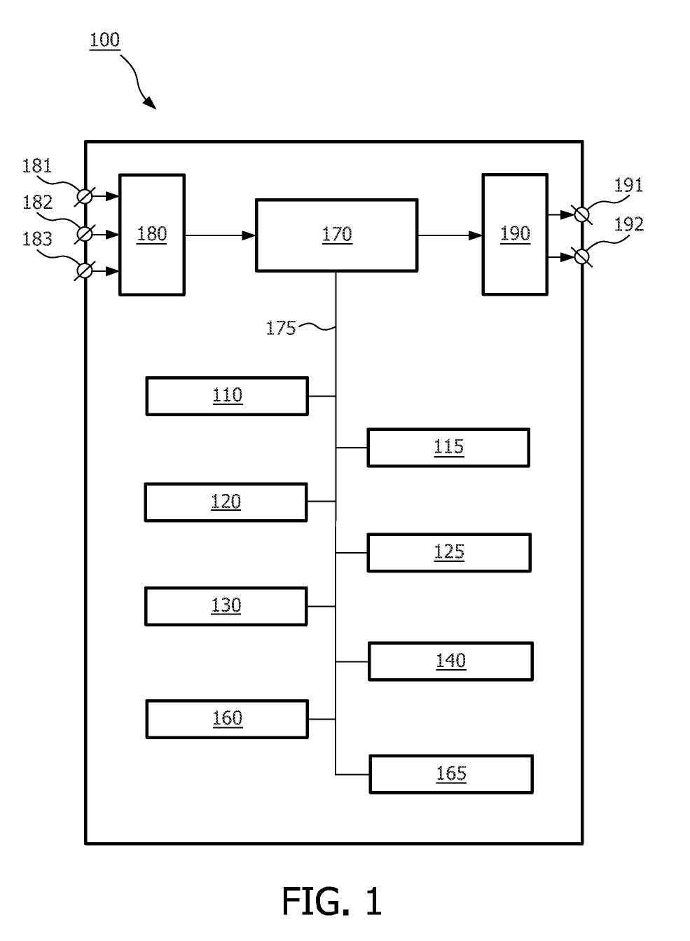

FIG. 1 schematically shows a block diagram of an exemplary embodiment of the system 100 for identifying a document of a plurality of documents, based on a multidimensional image, the system 100 comprising:

an object unit 110 for identifying an object represented in the multidimensional image, based on a user input indicating a region of the multidimensional image, and further based on a model for modeling the object, determined by segmentation of the indicated region of the multidimensional image;

a keyword unit 120 for identifying a keyword of a plurality of keywords, related to the identified object, based on an annotation of the model for modeling the object; and

a document unit 130 for identifying the document of the plurality of documents, based on the identified keyword.

The exemplary embodiment of the system 100 further comprises

a fragment unit 125 for labeling text fragments of documents with labels comprising keywords of the plurality of keywords, and wherein the document is identified by the document unit 130, based on the labels;

a category unit 115 for identifying a category of the object represented in the multidimensional image, and wherein the object unit 110 is adapted to identify the object further, based on the identified category of the object;

a retrieval unit 140 for retrieving the identified document;

a control unit 160 for controlling the work of the system 100;

a user interface 165 for communication between the user and the system 100; and

a memory unit 170 for storing data.

In an embodiment of the system 100, there are three input connectors 181, 182 and 183 for the incoming data. The first input connector 181 is arranged to receive data coming in from a data storage means such as, but not limited to, a hard disk, a magnetic tape, a flash memory, or an optical disk. The second input connector 182 is arranged to receive data coming in from a user input device such as, but not limited to, a mouse or a touch screen. The third input connector 183 is arranged to receive data coming in from a user input device such as a keyboard. The input connectors 181, 182 and 183 are connected to an input control unit 180.

In an embodiment of the system 100, there are two output connectors 191 and 192 for the outgoing data. The first output connector 191 is arranged to output the data to a data storage means such as a hard disk, a magnetic tape, a flash memory, or an optical disk. The second output connector 192 is arranged to output the data to a display device. The output connectors 191 and 192 receive the respective data via an output control unit 190.

A person skilled in the art will understand that there are many ways to connect input devices to the input connectors 181, 182 and 183 and the output devices to the output connectors 191 and 192 of the system 100. These ways comprise, but are not limited to, a wired and a wireless connection, a digital network such as, but not limited to, a Local Area Network (LAN) and a Wide Area Network (WAN), the Internet, a digital telephone network, and an analog telephone network.

In an embodiment of the system 100, the system 100 comprises a memory unit 170. The system 100 is arranged to receive input data from external devices via any of the input connectors 181, 182, and 183 and to store the received input data in the memory unit 170. Loading the input data into the memory unit 170 allows quick access to relevant data portions by the units of the system 100. The input data comprises the multidimensional image and the user input. The memory unit 170 may be implemented by devices such as, but not limited to, a register file of a CPU, a cache memory, a Random Access Memory (RAM) chip, a Read Only Memory (ROM) chip, and/or a hard disk drive and a hard disk. The memory unit 170 may be further arranged to store the output data. The output data comprises the identified document. The output data may also comprise, for example, a list comprising candidate objects, a list comprising candidate keywords, and/or a list comprising candidate documents. The memory unit 170 may be also arranged to receive data from and/or deliver data to the units of the system 100 comprising the object unit 110, the category unit 115, the keyword unit 120, the fragment unit 125, the document unit 130, the retrieval unit 140, the control unit 160, and the user interface 165, via a memory bus 175. The memory unit 170 is further arranged to make the output data available to external devices via any of the output connectors 191 and 192. Storing data from the units of the system 100 in the memory unit 170 may advantageously improve performance of the units of the system 100 as well as the rate of transfer of the output data from the units of the system 100 to external devices.

In an embodiment of the system 100, the system 100 comprises a control unit 160 for controlling the system 100. The control unit 160 may be arranged to receive control data from and provide control data to the units of the system 100. For example, after identifying the object, the object unit 110 may be arranged to provide control data “the object is identified” to the control unit 160, and the control unit 160 may be arranged to provide control data “identify the keywords” to the keyword unit 120. Alternatively, a control function may be implemented in another unit of the system 100.

In an embodiment of the system 100, the system 100 comprises a user interface 165 for communication between a user and the system 100. The user interface 165 may be arranged to receive a user input for identifying an object in the multidimensional image, for selecting a candidate keyword from the set of candidate keywords etc. Optionally, the user interface may receive a user input for selecting a mode of operation of the system such as, e.g., selection of a model for image segmentation. The user interface may be further arranged to display useful information to the user, e.g. a score of a candidate document for selection as the identified document. A person skilled in the art will understand that more functions may be advantageously implemented in the user interface 165 of the system 100.

In an embodiment, the documents are medical reports. The system 100 is adapted for identifying a medical report relevant to a case studied by a radiologist examining a 2-D brain image from a stack of 2-D brain images, each 2-D brain image being rendered from a CT slice of a stack of CT slices. The radiologist may indicate a region in the image, using an input device such as a mouse or a trackball. For example, the radiologist may draw a rectangular contour in the viewed image.

In an embodiment of the object unit 110 of the system 100, the user input indicating a region of the multidimensional image may be the whole image. In such a case it may not be required to draw a contour comprising the whole image. In particular, selecting a 2-D image from the stack of brain images may be interpreted as selecting a region—the whole image—where an object is to be identified by the object unit 110.

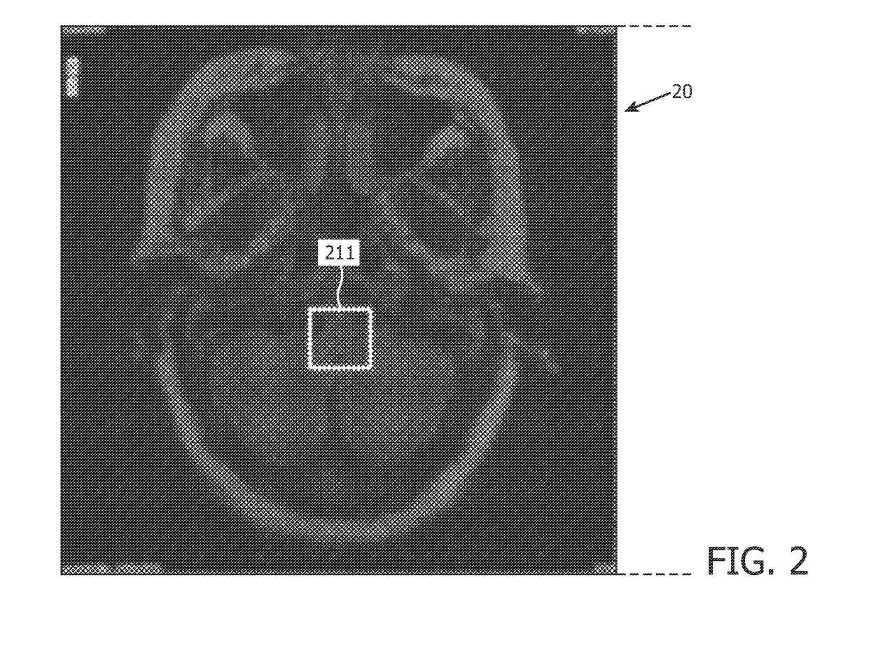

FIG. 2 shows an exemplary graphical user interface of the system according to an exemplary embodiment. The user-radiologist is provided with a brain image 20. He has drawn a rectangle 211 indicating a region in the image 20. The object unit 110 is adapted to interpret the indicated region on the basis of image segmentation.

The object of image segmentation is classifying pixels or voxels of an image as pixels or voxels describing an object represented in the image, thereby defining a model of the object. In one embodiment, pixels or voxels may be classified using a classifier for classifying pixels or voxels of the image. In another embodiment, pixels or voxels may be classified based on an object model, e.g. a deformable model, for adapting to the image. A person skilled in the art of image segmentation will know these and many other useful segmentation methods, which can be used by the system 100 of the invention. An exemplary 2-D model comprises a contour defined by a plurality of control points. An exemplary 3-D model comprises a mesh surface. Pixels on and/or inside the contour or voxels on and/or inside the mesh surface are classified as pixels or voxels belonging to the object. The object unit 110 of the system may be adapted for segmenting the image. Alternatively, the multidimensional image may be segmented and the results of the segmentation are used by the object unit 110 of the system 100. A person skilled in the art will know various segmentation methods and their implementations which may be used by the system 100 of the invention.

In an embodiment of the system 100, the stack of brain images constituting 3-D image data is segmented using model-based segmentation employing surface mesh models. The pixels in each 2-D brain image of the stack of brain images are thus classified based on the 3-D image segmentation results.

In an embodiment of the object unit 110 of the system 100, a region of a multidimensional image is determined by the position of the object model determined by segmentation of the image. For example, it can be a circle or rectangle (for 2-D images) or a sphere or parallelepiped (for 3-D images) comprising the pixels or voxels of the identified object. Selecting the multidimensional image and, optionally, an object model or classifier by the user may thus be interpreted as a user input for indicating a region of the image.

In an embodiment of the object unit 110 of the system 100, identifying the object represented in the multidimensional image comprises

displaying a set of candidate objects, each candidate object being identified based on the user input indicating the region of the multidimensional image, and further based on a model for modeling the candidate object, determined by segmentation of the indicated region of the multidimensional image; and

obtaining a user input for selecting a candidate object from the displayed set of candidate objects, thereby identifying the object.

In the first column 21, FIG. 2 shows a list of candidate objects identified based on the region 211 drawn on the brain image 20.

In an embodiment of the object unit 110 of the system 100, identifying the object represented in the multidimensional image comprises computing and displaying a score of each candidate object of the set of candidate objects. The non-parenthesized numbers to the right of the candidate objects listed on the list shown in column 21 are the scores. In an embodiment of the object unit 110, the scores are computed using the formula (Y/X)^{a} (Y/Z)^{b} (X/M)^{c} wherein:
X=the number of pixels classified as pixels of the object in the viewed image of the stack of images,
Y=the number of pixels classified as pixels of the object and comprised inside the rectangle drawn by the user in the viewed image of the stack of images,
Z=the number of image pixels inside the rectangle drawn by the user in the viewed image of the stack of images, and
M=the maximum number of pixels of the object in any image of the stack of images, and wherein a, b and c are exponents determined experimentally (equaling, e.g. 1.3, 0.4 and 1).

In an embodiment, the system 100 of the invention further comprises a category unit 115 for identifying a category of the object represented in the multidimensional image, and the object unit 110 is adapted to identify the object further based on the identified category of the object. The category may indicate, for example, location (e.g. left or right half of the body) or type of a vessel (e.g. vein or artery), which may be modeled by the same mesh model. Based on the body location, the object unit may be also adapted to identify an object comprising a segmented object in whole or in part. For example, based on the body location and a segmented tumor object, the organ attacked by the tumor may be identified by the object unit 110. Thus, in an embodiment, the category of the object represented in the multidimensional image is a position of the object, and the category unit 115 is adapted to identify the position of the object based on a reference object identified in the multidimensional image. To identify more objects in the multidimensional image, which are not segmented, the category unit 115 is adapted to explore the spatial arrangement of the anatomy represented in the multidimensional image, based on the objects identified by image segmentation. This can be done with the help of ontologies, such as SNOMED CT (see http://www.ihtsdo.org/snomed-ct/) and/or UMLS (see http://www.nlm.nih.gov/research/umls/). The ontologies may comprise body locations that encompass the identified object model and the spatial relations between the identified object and other objects. For example, other objects may be parts of the identified objects or vice versa. Optionally, the category unit 115 may be integrated with the object unit 110.

An object identified based on the category identified by the category unit 115 may be also assigned a score. In an embodiment, the spatial relations between the identified reference object and the object identified based on the object category may comprise a function indicating what percentage of the object identified based on the object category is comprised in the indicated region, depending on the location and/or shape of the region. For instance, if the tegmentum of pons is the reference object, 80% of the pons is on average comprised in the indicated region. Inversely, if the pons is the reference object and is fully comprised in the indicated region, 100% of the tegmentum of pons is comprised in the indicated region.

Thus, the spatial reasoning engine can “explode” a given body location by walking up and down the spatial relations to other body locations and computing the portions which are comprised in the indicated region, given the location and shape of the indicated region and the portion of the reference object which is comprised in the indicated region. This “explosion” step results in new objects identified by the object unit 110 and their scores.

Optionally, the category unit 115 may be integrated with the object unit 110.

The models or model parts are associated with keywords. Alternatively or additionally, classes of pixels or voxels classified in the process of image segmentation may be associated with keywords. The keywords may describe clinical findings relevant to the object. In some implementations, these keywords may depend on the actual shape of the object determined by image segmentation. For example, image segmentation of a blood vessel may indicate a stenosis or occlusion of the vessel. Thus, a keyword “stenosis” or “occlusion” may be used in relation to the vessel in line with the image segmentation result. A person skilled in the art will understand that the keywords may be single or multiple words such as names, phrases or sentences.

In an embodiment of the keyword unit 120 of the system 100, identifying the keyword of the plurality of keywords, related to the identified object, comprises:

displaying a set of candidate keywords of the plurality of keywords, each candidate keyword being related to the identified object, based on an annotation of the model for modeling the object; and

obtaining a user input for selecting a candidate keyword from the displayed set of candidate keywords, thereby identifying the keyword. In the second column 22 in FIG. 2, a list of candidate keywords identified by the keyword unit 120, relating to the objects identified by the object unit 110 and listed in the first column 21 in FIG. 2, is shown. Identifying the keyword represented in the multidimensional image comprises computing and displaying a score of each candidate keyword of the set of candidate keywords. The score is given by the non-parenthesized number to the right of each keyword. In an embodiment, the score is defined as the sum of products of the score of the keyword comprised in the object model used for identifying the object by the score of the object, the sum running over all identified objects the models of which comprise the keyword.

In an embodiment of the document unit 130 of the system 100, identifying the document of the plurality of documents comprises:

displaying a set of candidate documents of the plurality of documents, each candidate document being identified based on the identified keyword; and

obtaining a user input for selecting a candidate document from the displayed set of candidate documents, thereby identifying the document.

The third column 23 in FIG. 2 comprises a list of identifiers (IDs) of candidate documents identified by the document unit 130, corresponding to the keywords in the second column 22 in FIG. 2, identified by the keyword unit 120. Identifying the document represented in the multidimensional image comprises computing and displaying a score of each candidate document of the set of candidate documents. In an embodiment, the score is based on the number and frequency of occurrence of the keywords identified by the keyword unit. In the example shown in FIG. 2D, these are all keywords listed in the second column, i.e. all candidate keywords are selected by a user as the keywords identified by the keyword unit. The scores are displayed to the right of each report ID. Under each report ID, the keywords found in the report are also listed. The user can now select one or more candidate medical reports to be the reports identified by the document unit 130. The retrieval unit 140 may be further arranged to retrieve the identified reports. The retrieved reports help the user-radiologist to interpret the viewed brain image 20 in FIG. 2.

In an embodiment, the system 100 further comprises a fragment unit 125 for labeling text fragments of documents with labels comprising keywords of the plurality of keywords, and wherein the document is identified by the document unit 130 based on the labels. A natural language processing (NLP) tool structures and labels the “raw” natural language from radiology reports using MedLEE (see Carol Friedman et al., “Representing information in patient reports using natural language processing and the extensible markup language”, JAMIA 1999(6),76-87). In one of its modes MedLEE adds an XML document to a given radiology report. This XML document labels fragments of the text in terms of body locations, findings, sections, etc. It also adds modifiers to these labels that specify further information such as specifications (“large”, “lateral”), level of certainty and mappings to UMLS. The document unit 130 is adapted for identifying the document, based on a comparison of identified keywords with the body locations and observations from the XML document.

A person skilled in the art will appreciate that the system 100 may be a valuable tool for assisting a physician in many aspects of her/his job. Further, although the embodiments of the system are illustrated using medical applications of the system, non-medical applications of the system are also contemplated.

Those skilled in the art will further understand that other embodiments of the system 100 are also possible. It is possible, among other things, to redefine the units of the system and to redistribute their functions. Although the described embodiments apply to medical images, other applications of the system, not related to medical applications, are also possible.

The units of the system 100 may be implemented using a processor. Normally, their functions are performed under the control of a software program product. During execution, the software program product is normally loaded into a memory, like a RAM, and executed from there. The program may be loaded from a background memory, such as a ROM, hard disk, or magnetic and/or optical storage, or may be loaded via a network like the Internet. Optionally, an application-specific integrated circuit may provide the described functionality.

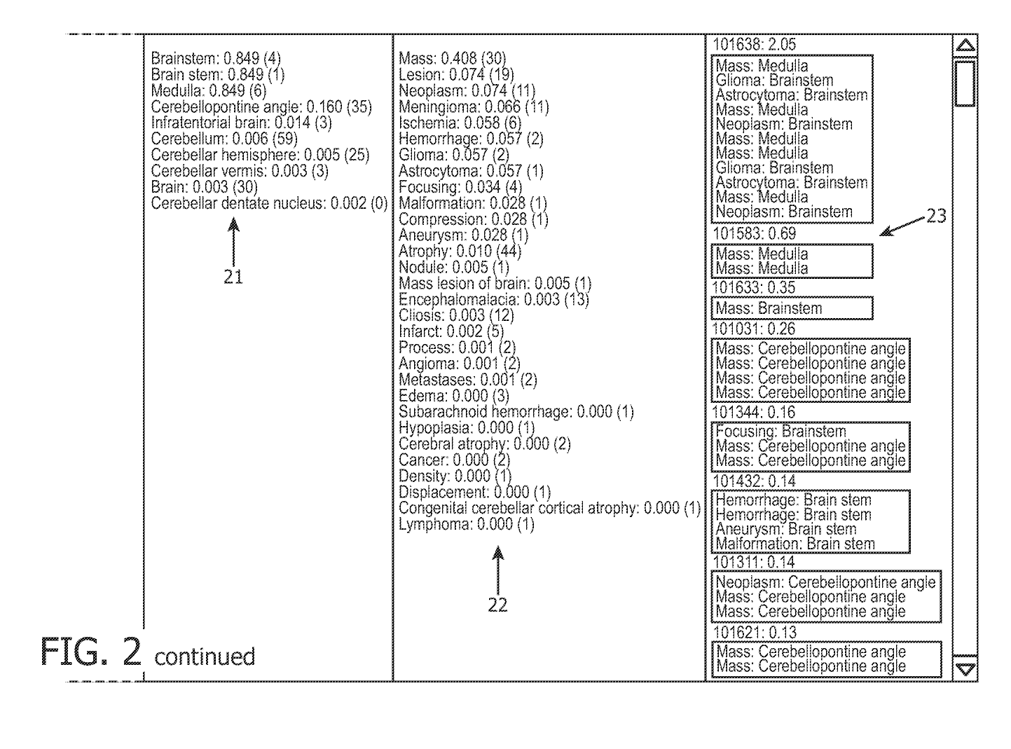

An exemplary flowchart of the method M of identifying a document of a plurality of documents, based on a multidimensional image, is schematically shown in FIG. 3. The method M begins with an object step S10 for identifying an object represented in the multidimensional image, based on a user input indicating a region of the multidimensional image, and further based on a model for modeling the object, determined by segmentation of the indicated region of the multidimensional image. After the object step S10, the method M continues to a keyword step S20 for identifying a keyword of a plurality of keywords, related to the identified object, based on an annotation of the model for modeling the object. After the keyword step S20, the method M continues to a document step S30 for identifying the document of the plurality of documents, based on the identified keyword. After the document step S30, the method terminates.

A person skilled in the art may change the order of some steps or perform some steps concurrently using threading models, multi-processor systems or multiple processes without departing from the concept as intended by the present invention. Optionally, two or more steps of the method M may be combined into one step. Optionally, a step of the method M may be split into a plurality of steps.

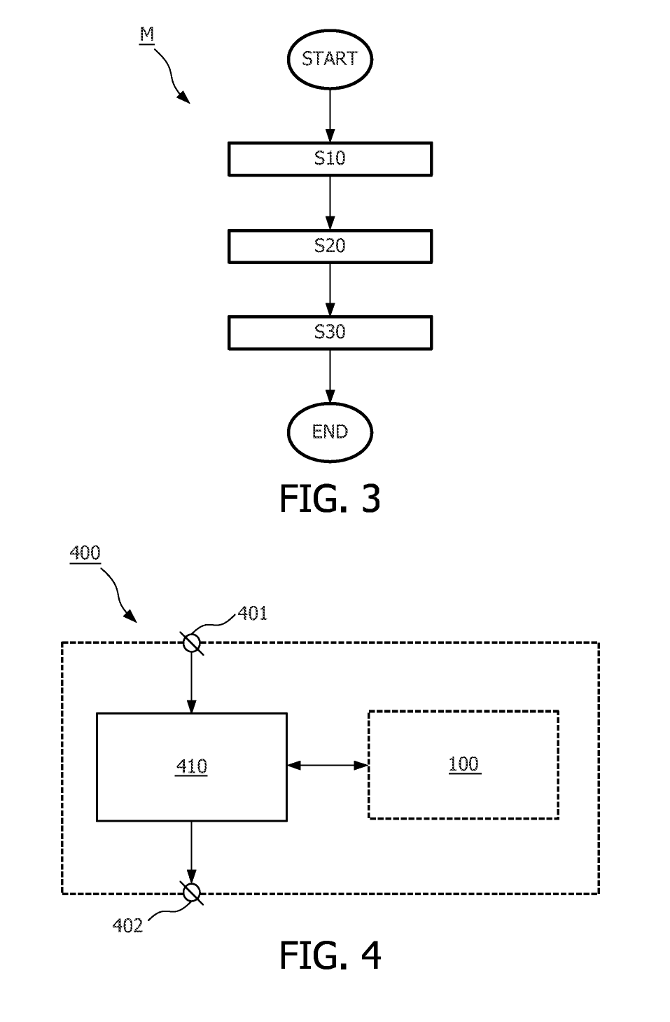

FIG. 4 schematically shows an exemplary embodiment of the database system 400 employing the system 100 of the invention, said database system 400 comprising a database unit 410 connected via an internal connection to the system 100, an external input connector 401, and an external output connector 402. This arrangement advantageously increases the capabilities of the database system 400, providing said database system 400 with advantageous capabilities of the system 100.

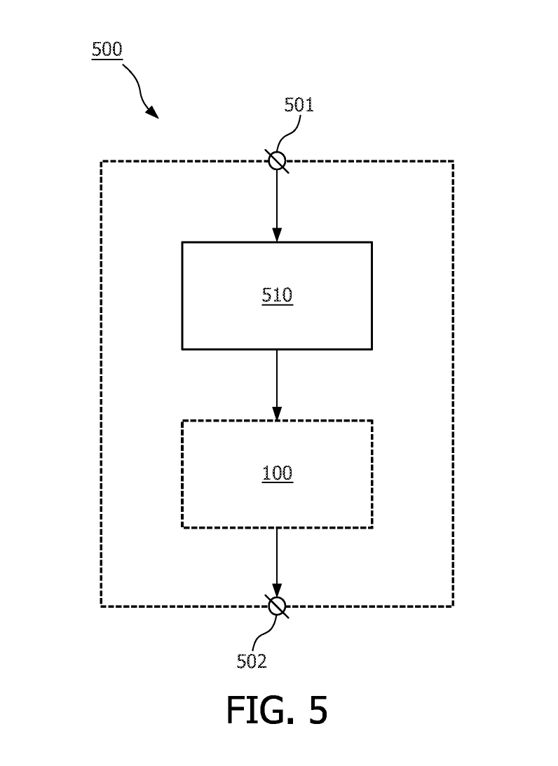

FIG. 5 schematically shows an exemplary embodiment of the image acquisition apparatus 500 employing the system 100 of the invention, said image acquisition apparatus 500 comprising an image acquisition unit 510 connected via an internal connection with the system 100, an input connector 501, and an output connector 502. This arrangement advantageously increases the capabilities of the image acquisition apparatus 500, providing said image acquisition apparatus 500 with advantageous capabilities of the system 100.

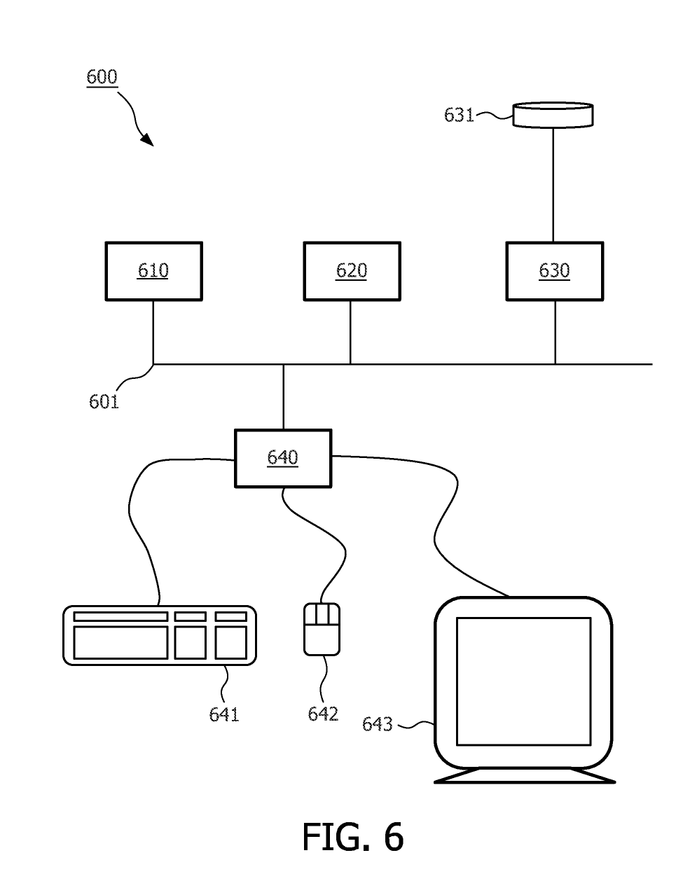

FIG. 6 schematically shows an exemplary embodiment of the workstation 600. The workstation comprises a system bus 601. A processor 610, a memory 620, a disk input/output (I/O) adapter 630, and a user interface (UI) 640 are operatively connected to the system bus 601. A disk storage device 631 is operatively coupled to the disk I/O adapter 630. A keyboard 641, a mouse 642, and a display 643 are operatively coupled to the UI 640. The system 100 of the invention, implemented as a computer program, is stored in the disk storage device 631. The workstation 600 is arranged to load the program and input data into memory 620 and execute the program on the processor 610. The user can input information to the workstation 600, using the keyboard 641 and/or the mouse 642. The workstation is arranged to output information to the display device 643 and/or to the disk 631. A person skilled in the art will understand that there are numerous other embodiments of the workstation 600 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same record of hardware or software. The usage of the words first, second, third, etc., does not indicate any ordering. These words are to be interpreted as names.

1. (Original) A system (100) for identifying a document of a plurality of documents, based on a multidimensional image, the system (100) comprising:
an object unit (110) for identifying an object represented in the multidimensional image, based on a user input indicating a region of the multidimensional image, and further based on a model for modeling the object, determined by segmentation of the indicated region of the multidimensional image;
a keyword unit (120) for identifying a keyword of a plurality of keywords, related to the identified object, based on an annotation of the model for modeling the object; and
a document unit (130) for identifying the document of the plurality of documents, based on the identified keyword.

2. A system (100) as claimed in claim 1, wherein identifying the object represented in the multidimensional image comprises:
displaying a set of candidate objects, each candidate object being identified based on the user input indicating the region of the multidimensional image, and further based on a model for modeling the candidate object, determined by segmentation of the indicated region of the multidimensional image; and
obtaining a user input for selecting a candidate object from the displayed set of candidate objects, thereby identifying the object.

3. A system (100) as claimed in claim 2, wherein identifying the object represented in the multidimensional image comprises computing and displaying a score of each candidate object of the set of candidate objects.

4. A system (100) as claimed in claim 1, wherein identifying the keyword of the plurality of keywords, related to the identified object, comprises:
displaying a set of candidate keywords of the plurality of keywords, each candidate keyword being related to the identified object, based on an annotation of the model for modeling the object; and
obtaining a user input for selecting a candidate keyword from the displayed set of candidate keywords, thereby identifying the keyword.

5. A system (100) as claimed in claim 4, wherein identifying the keyword represented in the multidimensional image comprises computing and displaying a score of each candidate keyword of the set of candidate keywords.

6. A system (100) as claimed in claim 1, wherein identifying the document of the plurality of documents comprises:
displaying a set of candidate documents of the plurality of documents, each candidate document being identified based on the identified keyword; and
obtaining a user input for selecting a candidate document from the displayed set of candidate documents, thereby identifying the document.

7. A system (100) as claimed in claim 6, wherein identifying the document represented in the multidimensional image comprises computing and displaying a score of each candidate document of the set of candidate documents.

8. A system (100) as claimed in claim 1, further comprising a fragment unit (125) for labeling text fragments of documents with labels comprising keywords of the plurality of keywords, and wherein the document is identified by the document unit (130), based on the labels.

9. A system (100) as claimed in claim 1, further comprising a category unit (115) for identifying a category of the object represented in the multidimensional image, and wherein the object unit (110) is adapted to identify the object further, based on the identified category of the object.

10. A system (100) as claimed in claim 6, wherein the category of the object represented in the multidimensional image is a position of the object, and wherein the category unit (115) is adapted to identify the position of the object, based on a reference object identified in the multidimensional image.

11. A system (100) as claimed in claim 1, further comprising a retrieval unit (140) for retrieving the identified document.

12. A database comprising a system (100) as claimed in claim 1.

13. An image acquisition apparatus (500) comprising a system (100) as claimed in claim 1.

14. A workstation (600) comprising a system (100) as claimed in claim 1.

15. A method (M) of identifying a document of a plurality of documents, based on a multidimensional image, the method (M) comprising:
an object step (S10) for identifying an object represented in the multidimensional image, based on a user input indicating a region of the multidimensional image, and further based on a model for modeling the object, determined by segmentation of the indicated region of the multidimensional image;
a keyword step (S20) for identifying a keyword of a plurality of keywords, related to the identified object, based on an annotation of the model for modeling the object; and
a document step (S30) for identifying the document of the plurality of documents, based on the identified keyword.

16. A computer program product to be loaded by a computer arrangement, comprising instructions for retrieving a document of a plurality of documents, based on a multidimensional image, the computer arrangement comprising a processing unit and a memory, the computer program product, after being loaded, providing said processing unit with the capability to carry out steps of a method as claimed in claim 14.
